(19) United States
(12) Patent Application Publication
(10) Pub. No.: US 2023/0149234 A1
(43) Pub. Date: May 18, 2023

(54) TRANSFER DEVICE

(71) Applicant: Funai Electric Co., Ltd., Daito (JP)

(72) Inventors: Manabu MURAYAMA, Itami (JP); Naoyuki WAKABAYASHI, Osaka (JP)

(21) Appl. No.: 17/981,957

(22) Filed: Nov. 7, 2022

(30) Foreign Application Priority Data
Nov. 16, 2021 (JP) 2021-186629

(51) Int. Cl. A61G 7/10

(52) U.S. Cl. CPC A61G 7/1059; A61G 7/1046

(57) ABSTRACT

A transfer device comprises a support frame, a seat member, a support member, at least one caster, and a handle member. A care-receiver is configured to be seated on the seat member. The seat member is attached to the support frame and is foldable or extendable. The support member is attached to the support frame. The support member is configured to support an upper body of the care-receiver from front. The at least one caster is provided below the support frame. The handle member is attached to the support member. The handle member is movable in a front-back direction of the support frame and is configured to be grasped by a caregiver during a transfer.

### CROSS-REFERENCE TO RELATED APPLICATIONS

This application claims priority to Japanese Patent Application No. 2021-186629 filed in Japan on Nov. 16, 2021. The entire disclosure of Japanese Patent Application No. 2021-186629 is hereby incorporated herein by reference.

### BACKGROUND

### Field of the Invention

This invention generally relates to a transfer device. More specifically, this invention relates to a transfer device equipped with a handle member and a seat member.

### Background Information

Generally, a transfer device is equipped with a handle member and a seat member (see Japanese Laid-Open Patent Application Publication No. 2020-168307 (Patent Literature 1), for example).

Patent Literature 1 above discloses a transfer device equipped with a main frame, a seat portion, and a grasping lever to be grasped by a caregiver. With the transfer device disclosed in Patent Literature 1 above, a care-receiver is transferred in a state in which the care-receiver is seated on the seat portion.

### SUMMARY

With the transfer device disclosed in Patent Literature 1 above, the grasping lever is fixedly disposed in front of the main frame, and the seat portion is disposed behind the main frame. Furthermore, with the transfer device disclosed in Patent Literature 1 above, the transfer device is moved in a state in which the caregiver and the care-receiver are facing each other after the care-receiver is seated on the seat portion in a state in which the caregiver and the care-receiver is facing each other. Therefore, one of the caregiver and the care-receiver will turn his/her back in the direction of movement.

When the caregiver moves the transfer device in a state in which his/her back is facing the direction of movement, the caregiver may stumble on a step or come into contact with an obstacle. On the other hand, when the care-receiver moves in a state in which his/her back is facing the direction of movement, the care-receiver may not be able to see the direction of travel, making the ride uncomfortable.

On the other hand, although not disclosed in Patent Literature 1 above, when the grasping lever is disposed behind the main frame, the grasping lever is disposed on the side of the seat portion so that it does not come in contact with the care-receiver. Therefore, when transferring a care-receiver, the transfer device cannot be placed on the side of the object for seating to transfer the care-receiver from the side, and the caregiver must seat the care-receiver from the front while holding the care-receiver, which results in poor operability.

One object of this disclosure is to provide a transfer device that can improve the ride comfort of the care-receiver while improving operability.

In view of the state of the known technology, a transfer device according to an aspect of this disclosure comprises a support frame, a seat member, a support member, at least one caster, and a handle member. A care-receiver is configured to be seated on the seat member. The seat member is attached to the support frame and is foldable or extendable. The support member is attached to the support frame. The support member is configured to support an upper body of the care-receiver from front. The at least one caster is provided below the support frame. The handle member is attached to the support member. The handle member is movable in a front-back direction of the support frame and is configured to be grasped by a caregiver during a transfer.

### BRIEF DESCRIPTION OF THE DRAWINGS

Referring now to the attached drawings which form a part of this original disclosure;

FIG. 1 is a schematic diagram of the entirety of a transfer device according to a first embodiment.

FIG. 2 is a diagram showing a state in which a seat member is extended.

FIG. 3 is a diagram showing a state in which the seat member is retracted.

FIG. 4 is a diagram showing a state in which a handle member is located in a forward position.

FIG. 5 is a diagram showing a state in which the handle member is located in a rearward position.

FIG. 6A is a diagram showing a handle in a locked state.

FIG. 6B is a cross-sectional view illustrating the locked state.

FIG. 7A is a diagram showing the handle in an unlocked state.

FIG. 7B is a cross-sectional view illustrating the unlocked state.

FIG. 8A is a front view showing a state in which a care-receiver is sitting on a bed.

FIG. 8B is a side view showing the state in which the care-receiver is sitting on the bed.

FIG. 9 is a diagram showing a state in which the transfer device is moved to the bed.

FIG. 10 is a diagram showing a state in which the transfer device is brought close to the bed.

FIG. 11 is a diagram showing the arrangement of the bed and the care-receiver during a transfer.

FIG. 12 is a diagram showing a state in which the transfer device is moved between the bed and the care-receiver.

FIG. 13 is a diagram showing a state in which a first holding portion and a second holding portion are attached to the care-receiver.

FIG. 14 is a diagram showing a state in which the posture of the care-receiver is changed.

FIG. 15 is a diagram showing a state in which the transfer device is moved to extend the seat member.

FIG. 16 is a diagram showing a state in which the seat member is extended.

FIG. 17 is a diagram showing a state in which the care-receiver is seated on the seat member.

FIG. 18 is a diagram showing a state in which the position of the handle member is changed from the forward position to the rearward position.

FIG. 19 is a diagram showing a state after the transfer device is moved.

FIG. 20 is a diagram showing a state in which the position of the handle member is moved from the rearward position to the forward position.

FIG. 21 is a diagram showing a state in which the posture of the care-receiver is changed.

FIG. 22 is a diagram showing a state in which the seat member is retracted.

FIG. 23 is a diagram showing a state in which the transfer device is moved closer to a toilet.

FIG. 24 is a diagram showing a state in which the care-receiver is seated on the toilet.

FIG. 25 is a diagram showing a transfer device according to a second embodiment.

FIG. 26 is a flowchart showing an operation flow in which a first sensor, a second sensor and a drive mechanism operate in cooperation.

FIG. 27 is a diagram of a handle member according to a modification example.

FIG. 28 is a diagram showing a seat member according to a modification example.

FIG. 29 is a diagram showing a support member according to a modification example.

### DETAILED DESCRIPTION OF EMBODIMENTS

Selected embodiments will now be explained with reference to the drawings. It will be apparent to those skilled in the art from this disclosure that the following descriptions of the embodiments are provided for illustration only and not for the purpose of limiting the invention as defined by the appended claims and their equivalents.

### First Embodiment

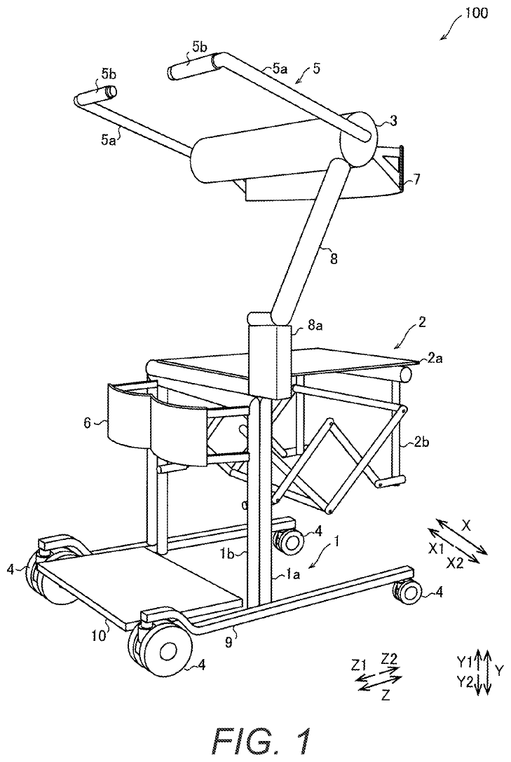

First, with reference to FIGS. 1 to 8, the configuration of a transfer device 100 according to a first embodiment will be described.

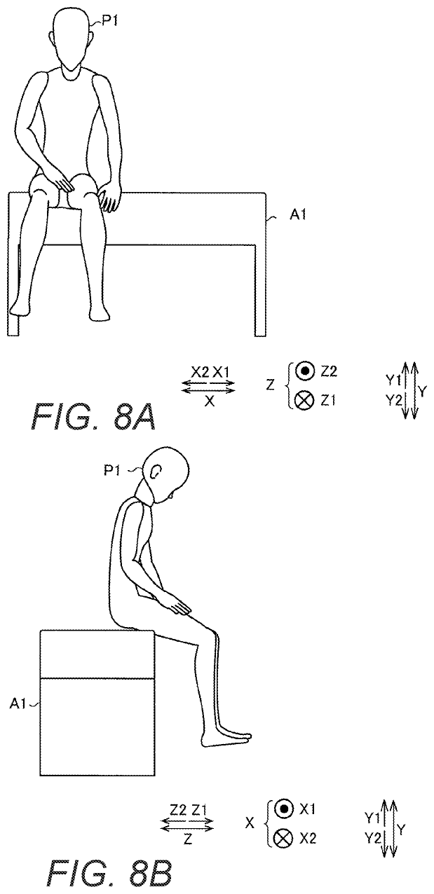

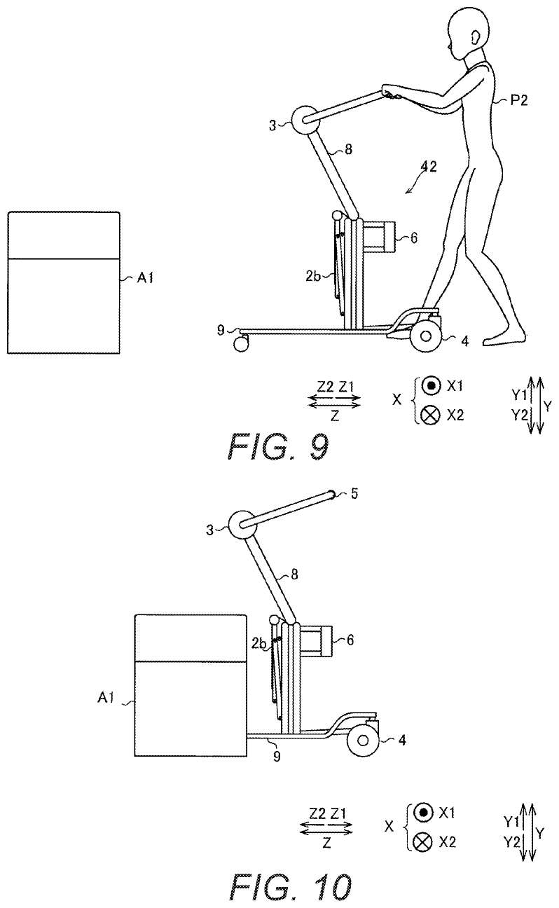

As shown in FIG. 1, the transfer device 100 according to the first embodiment comprises a support frame 1, a seat member 2, a support member 3, a plurality of casters 4, and a handle member 5. The transfer device 100 is a device for moving a care-receiver P1 who is in need of care from one place (e.g., a bed) to another place (e.g., a toilet or bath). The term “transfer” refers to changing objects on which the care-receiver P1 (see FIG. 8) is seated, and includes, for example, moving the care-receiver P1 from the bed to the transfer device 100 and/or moving the care-receiver P1 from the transfer device 100 to the toilet. In the present disclosure, a caregiver P2 (see FIG. 9) includes a person who takes care of the care-receiver P1, and includes so-called home helpers, nurses, and family members. In addition, in the present disclosure, when the care-receiver P1 is seated on the seat member 2, the front side of the care-receiver P1 is referred to as a Z1 side, the rear side is referred to as a Z2 side, and a front-back direction connecting the Z1 side and the Z2 side is referred to as a Z direction. Also, when the care-receiver P1 is seated on the seat member 2, the left side of the care-receiver is referred to as an X2 side, the right side is referred to as an X1 side, and a left-right direction connecting the X1 side and the X2 side is referred to an X direction. Furthermore, an up-down direction orthogonal to the X direction and the Z direction is referred to as a Y direction, with the upper side being referred to as a Y1 side and the lower side being referred to as a Y2 side.

The support frame 1 includes a first pillar 1a and a second pillar 1b having the same shape as the first pillar 1a. The first pillar 1A includes two pipes that face each other in the X direction and each extend in the Y direction, and a pipe that extends in the X direction to connect Y1 side end portions of the two pipes. The first pillar 1a and the second pillar 1b are disposed adjacent to each other in the Z direction. In FIG. 1, the first pillar 1a is located on the Z2 side and the second pillar 1b is located on the Z1 side. The first and second pillars 1a and 1b are not limited to be formed by pipes, but can be formed by cylindrical rods. The first and second pillars 1a and 1b can be made of metal.

Referring now to FIG. 1, the arrangement of various components of the transfer device 100 will be explained using the first pillar 1a and the second pillar 1b of the support frame 1 as a reference. A detailed description of each component other than the support frame 1 will be described later.

The seat member 2 is attached to the first pillar 1a. The seat member 2 includes a seat portion 2a and an extension and retraction mechanism 2b. Specifically, one end of the seat portion 2a of the seat member 2 is fixed to the upper end of the first pillar 1a. The extension and retraction mechanism 2b of the seat member 2 is attached to the Z2 side of the first pillar 1a. At the upper end of the first pillar 1a, the Y2 side end portion of a movable arm 8 extending in the Y direction is disposed via the seat portion 2a. The support member 3 is attached to the Y1 side end portion of the movable arm 8. The handle member 5 is attached to the support member 3. A second holding portion 7 is attached to the Z2 side of the support member 3.

A first holding portion 6 (e.g., a front holding portion) is attached to the Z1 side of the second pillar 1b. Also, a pair of base frames 9 extending in the Z direction are attached to the lower end portions of the first pillar 1a and the second pillar 1b. The casters 4 are attached to the Z1 side end portions and the Z2 side end portions of the base frames 9. In addition, a foot rest 10 is attached near the Z1 side end portions of the base frames 9. In the illustrated embodiment, the base frames 9 are laterally spaced away from each other in the X direction. The foot rest 10 is disposed between the base frames 9 in the X direction. The foot rest 10 is disposed forward of the lower end portions of the support frame 1.

The seat portion 2a of the seat member 2 is extendable and retractable. The extension and retraction mechanism 2b of the seat member 2 extends and retracts the seat portion 2a.

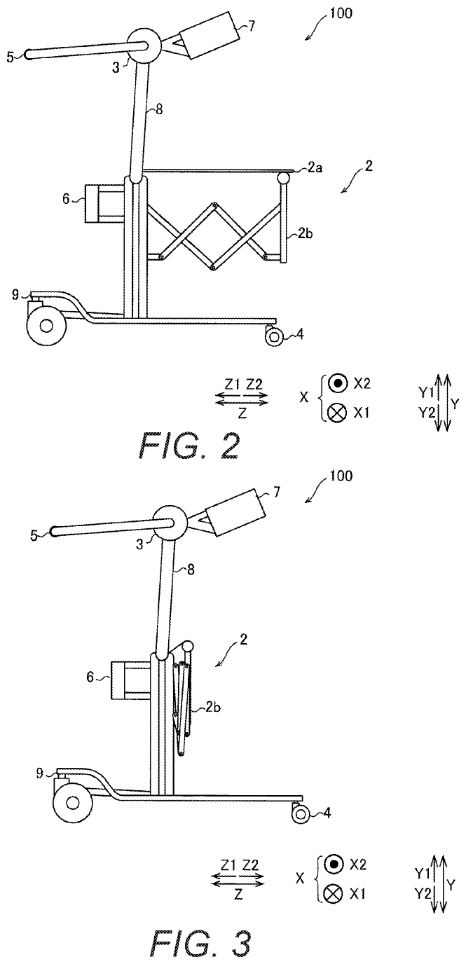

As shown in FIGS. 2 and 3, the seat portion 2a is extendable in the front-back direction (the Z direction). The seat portion 2a is made of fabric. The seat portion 2a may also include a cushion. The shape and size of the seat portion 2a is not particularly limited, but it should be of a shape and size that allows the care-receiver P1 to be seated stably. The seat portion 2a is configured so that the care-receiver P1 can be seated in the extended state. The Z1 side end portion of the seat portion 2a is fixed to the first pillar 1a. The seat portion 2a is extended and retracted when the Z2 side end portion is moved. The seat portion 2a is configured to be removable from the extension and retraction mechanism 2b. For example, the seat portion 2a is fixed in a state in which one end thereof is wrapped around the extension and retraction mechanism 2b, and can be removed by pulling out the wrapped portion from the extension and retraction mechanism 2b.

The extension and retraction mechanism 2b extends and retracts the seat portion 2a in the front-back direction. The extension and retraction mechanism 2b has, for example, a link or linkage mechanism, such as a scissors mechanism. The seat portion 2a is attached above the extension and retraction mechanism 2b (the Y1 side). The seat portion 2a is configured to be detachable from the extension and retraction mechanism 2b. The Z1 side end portion of the extension and retraction mechanism 2b is fixed to the first pillar 1a. The seat portion 2a is extended and retracted when the Z2 side end portion is moved.

As shown in FIG. 1, the support member 3 is a member for supporting the upper body of the care-receiver P1 from the front (the Z1 side). The support member 3 is cylindrical in shape and extends in the X direction. The support member 3 is formed from a soft material such as urethane. The support member 3 is used to change the posture of the care-receiver P1 during transfer. Specifically, when the handle member 5 is pushed down toward the Y2 side, the support member 3 is rotated, and the waist of the care-receiver P1 who is leaning on the support member 3 can be raised. When the handle member 5 is pushed up in the Y1 direction, the support member 3 is rotated, and the care-receiver P1 who is leaning on the support member 3 can be seated on the seat member 2 or another seatable member.

The casters 4 are attached below the support frame 1 via the base frames 9. A total of four casters 4, two each at the front and the rear, are provided. The casters 4 are configured such that the diameter of (the wheels of) the casters 4 provided rearward (the Z2 side) of the support frame 1 is smaller than the diameter of (the wheels of) the casters 4 provided forward (the Z1 side) of the support frame 1. The casters 4 are, for example, not only casters 4 that can move in the front-back direction (the Z direction), but also casters 4 that can move in the front-back direction (the Z direction) and in the left-right direction (the X direction). Thus, in the illustrated embodiment, the casters 4 include a pair of front casters 4 and a pair of rear casters 4, and the front casters 4 have a diameter that is larger than that of the rear casters 4.

The handle member 5 is provided on the X1 side and the X2 side of the support member 3, respectively. The handle member 5 has a pair of shaft portions 5a extending in a direction (the Z direction) that intersects the direction (the X direction) in which the support member 3 extends, and a pair of grasping portions 5b bent from the shaft portions 5a along the direction (the X direction) in which the support member 3 extends. The shaft portions 5a are disposed at the X1 side end portion and the X2 side end portion of the support member 3. The grasping portions 5b are located at the Z1 side end portions of the shaft portions 5a. The handle member 5 is grasped when being transferred and/or moved. The handle member 5 is made of metal or resin.

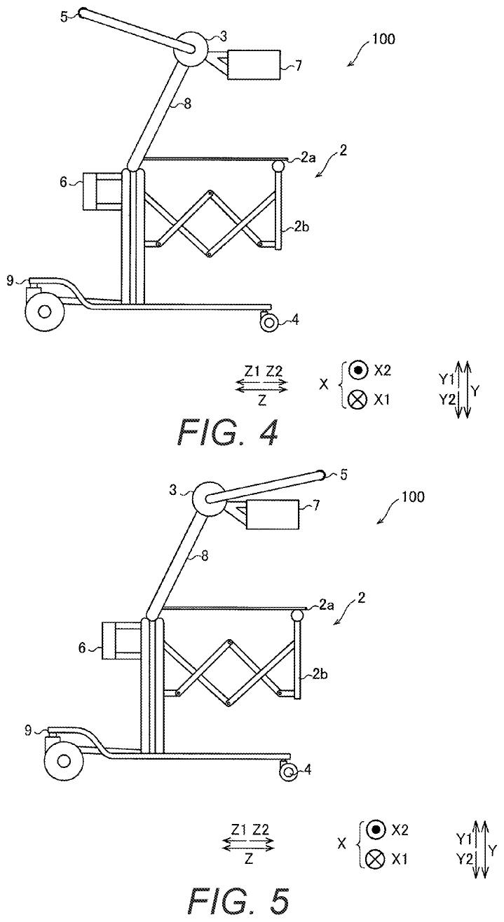

As shown in FIGS. 4 and 5, the handle member 5 can be rotated to change the position in the front-back direction of the support frame 1. Thus, the handle member 5 is movable in the front-back direction of the support frame 1 by being rotated. The handle member 5 has lock mechanisms 5c inside the shaft portions 5a to stop the rotation. In the illustrated embodiment, the lock mechanisms 5c are disposed inside the shaft portions 5a, but the present invention is not limited to this. For example, only one lock mechanism 5c can be disposed inside one of the shaft portions 5a.

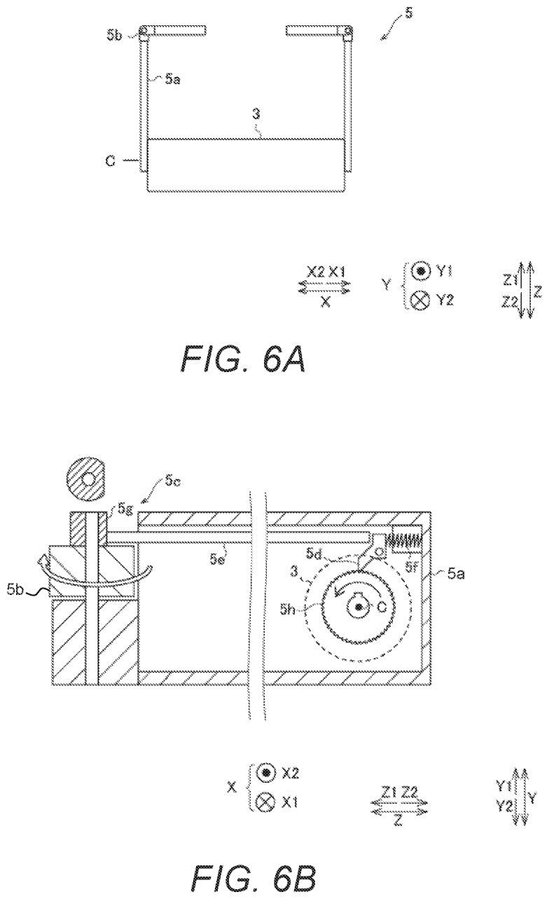

FIG. 6A is a diagram showing the handle member 5 as viewed from above (the Y1 side) in a state in which the handle member 5 is positioned in the front (the Z1 side) of the support frame 1 (a state shown in FIG. 4). FIG. 6B is a cross-sectional view of the shaft portion 5a taken along the Z direction. The lock mechanisms 5c are configured not to restrict the rotation to change the position of the handle member 5 from the Z1 side (forward) to the Z2 side (rearward), but are configured to restrict the rotation of the handle member 5 to change the position from the Z2 side to the Z1 side. The lock mechanisms 5c include, for example, a ratchet mechanism. As shown in FIG. 6B, the lock mechanisms 5c are each formed of a stopper 5d, a connecting rod 5e, a spring member 5f, and a cam 5g. The lock mechanisms 5c stop the rotation of the handle member 5 when the stopper 5d contacts a gear 5h that rotates the handle member 5. At this time, the spring member 5f is in an extended state, and specifically, is extended in a direction of pushing the stopper 5d against the gear 5h. The left and right handles of the handle member 5 rotate around the rotational center C synchronously by the gear 5h.

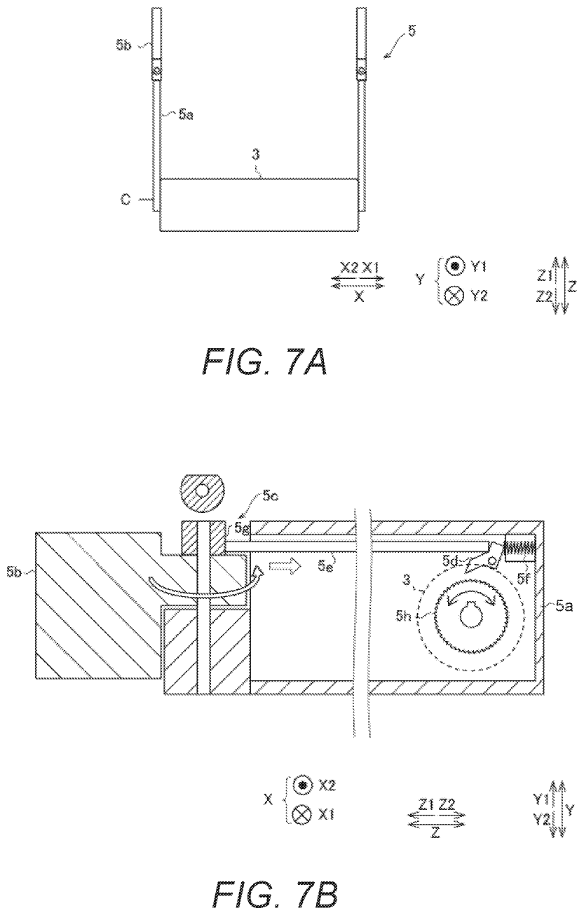

FIG. 7A is a diagram showing the handle member 5 as viewed from above (the Y1 side) in a state in which the handle member 5 is positioned in the front (the Z1 side) of the support frame 1 (a state shown in FIG. 4). FIG. 7B is a cross-sectional view of the shaft portion 5a taken along the Z direction. The lock mechanisms 5c are released by making the grasping portions 5b extend along the direction (the Z direction) that intersects the direction (the X direction) in which the support member 3 extends. As shown in FIG. 7B, when the grasping portions 5b are extended, the cam 5g rotates as indicated by the arrow to push the connecting rod 5e toward the stopper 5d. The stopper 5d that has been pushed by the connecting rod 5e moves away from the gear 5h to release the locked state. At this time, the stopper 5d pushes the spring member 5f in the direction to contract.

As shown in FIG. 1, the first holding portion 6 is a band-shaped member. The first holding portion 6 is fixed to one of a pair of pillars (pipes) of the support frame 1 opposing in the X direction, and is removably attached to the other. The first holding portion 6 is formed from an elastic and stretchable fabric. The first holding portion 6 is configured to contact the area of the care-receiver P1 below the knee. The first holding portion 6 serves as a support to prevent the care-receiver P1 from moving the Z1 direction when changing the posture while the care-receiver P1 is leaning against the support member 3. In the illustrated embodiment, the first holding portion 6 is disposed forward of the support frame 1 below the seat member 2. The first holding portion 6 is arranged such that the first holding portion 6 is configured to support the leg of the care-receiver P1 from the front.

The second holding portion 7 is a band-shaped member with one end being fixed to the support member 3 and the other end being removable. The second holding portion 7 is formed from an elastic and stretchable fabric. The second holding portion 7 contacts the upper body of the care-receiver P1 from behind (the Z2 side). By sandwiching the care-receiver P1 between the second holding portion 7 and the support member 3, the seated state of the care-receiver P1 can be maintained. In the illustrated embodiment, the second holding portion 7 is disposed rearward of the support frame 1 above the seat member 2. The second holding portion 7 is arranged such that the second holding portion 7 is configured to support the back of the care-receiver P1 between the second holding portion 7 and the support member 3.

The movable arm 8 is an arm extending in the Y direction. The movable arm 8 may be formed of a pipe or formed of a columnar member. The Y2 side end portion of the movable arm 8 is provided with a height adjustment mechanism 8a that can be extended or retracted in the Y direction. The movable arm 8 is configured to support the support member 3 in a cantilever manner at one end of lateral sides of the support member 3. The movable arm 8 is rotatable toward the Z1 side or the Z2 side together with the support member 3 by moving the handle member 5 in the Y direction.

The base frames 9 are provided below (the Y2 side) the seat member 2. The base frames 9 are formed of a pair of frames that extend parallel to each other and rearward from the lower end portions of the support frame 1 toward the front-back direction. The casters 4 are attached to the Z side end portions of the base frames 9. The base frames 9 are configured such that the height at the Z2 side is lower than the height (the length in the Y direction) at the Z1 side. The base frames 9 are configured so that the Z2 side end portions can be inserted into the gap between the object for seating and the floor (the ground). With the base frames 9, the pair of the frames are arranged spaced apart from each other so that the object for seating can be sandwiched between the Z2 side end portions that are located on the Z2 side than the support frame 1. The base frames 9 are made, for example, of metal.

The foot rest 10 is attached to the Z1 side end portions of the base frames 9. The foot rest 10 is a member on which the feet of the care-receiver P1 seated on the seat member 2 are placed. The foot rest 10 is, for example, made of metal or resin.

An example of a usage method of the transfer device 100 will be described based on FIGS. 8A to 24. In FIGS. 8A to 24, an example in which the care-receiver P1 is moved from a bed A1 to a toilet A2 using the transfer device 100. Here, the caregiver P2 is now shown, except for FIG. 9.

As shown in FIGS. 8A and 8B, the care-receiver P1 is seated on the bed A1. At this time, as shown in FIG. 8B, the care-receiver P1 is seated so that there is a gap between the legs of the care-receiver P1 and the bed A1. There is also a gap between the bed A1 and the floor.

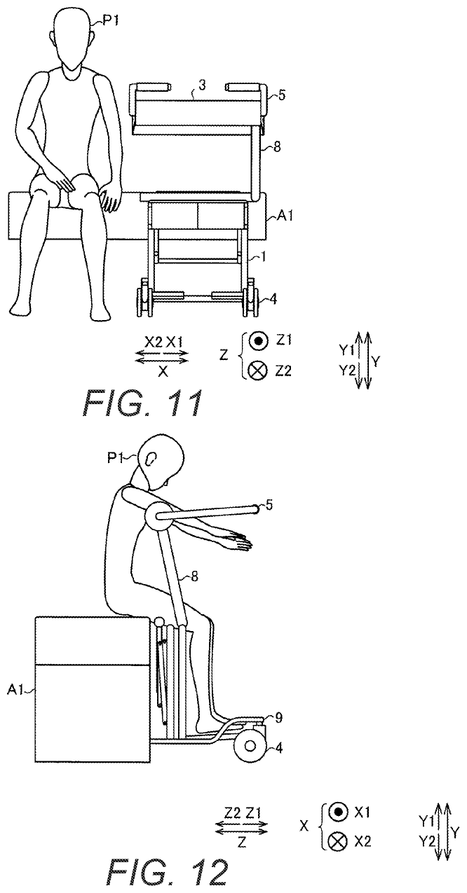

As shown in FIG. 9, the transfer device 100 is moved by the caregiver P2 in the Z2 direction toward the bed A1. Then, as shown in FIG. 10, the Z2 side end portions of the base frames 9 are inserted between the gap between the bed A1 and the floor. At this time, the care-receiver P1 and the transfer device 100 are placed side by side in the X direction as shown in FIG. 11. In the initial position of the transfer device 100, the seat member 2 is retracted and the handle member 5 is positioned on the Z1 side.

As shown in FIG. 12, the transfer device 100 is moved in the X direction so that it is positioned in the gap between the care-receiver P1 and the bed A1. At this time, the seat member 2 is in the retracted state. The transfer device 100 is positioned so that the care-receiver P1 can be seated in the center of the seat portion 2a when the seat member 2 is extended. The support member 3 supports the upper body of the care-receiver P1 from the front when the care-receiver P1 leans on the support member 3.

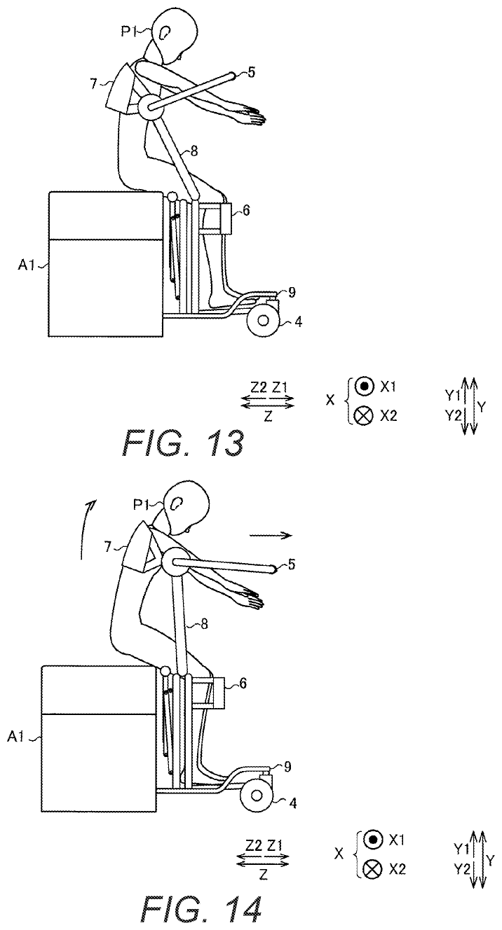

As shown in FIG. 13, one unfixed end of the second holding portion 7 is fixed to the support member 3 in a state in which the second holding portion 7 can contact the back of the care-receiver P1. At this time, the movable arm 8 is inclined toward the care-receiver P1. One unfixed end of the first holding portion 6 is fixed to the support frame 1 in a state in which the first holding portion 6 can contact the leg of the care-receiver P1.

As shown in FIG. 14, when the handle member 5 is pulled downward in the Z1 direction, the movable arm 8 rotates toward the Z1 direction. At this time, the movable arm 8 extends straight along the Y direction. As the movable arm 8 rotates, the support member 3 rotates to change the posture of the care-receiver P1 who is leaning on the support member 3. Specifically, the waist of the care-receiver P1 can be lifted. This facilitates the work of extending the folded seat member 2.

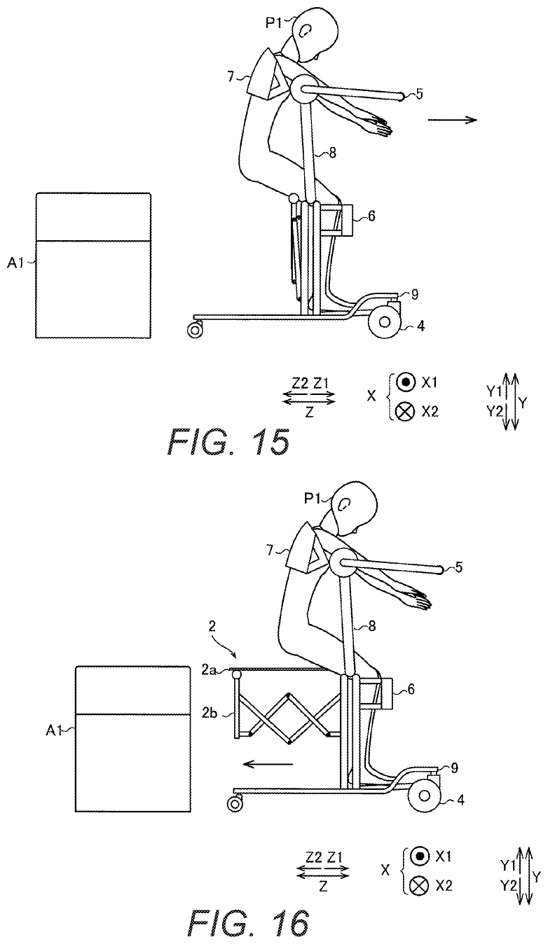

As shown in FIG. 15, in a state in which the care-receiver P1 is leaning on the support member 3, the transfer device 100 is moved in the Z1 direction. In this case, the transfer device 100 is moved by at least the length of the seat member 2 in the Z1 direction.

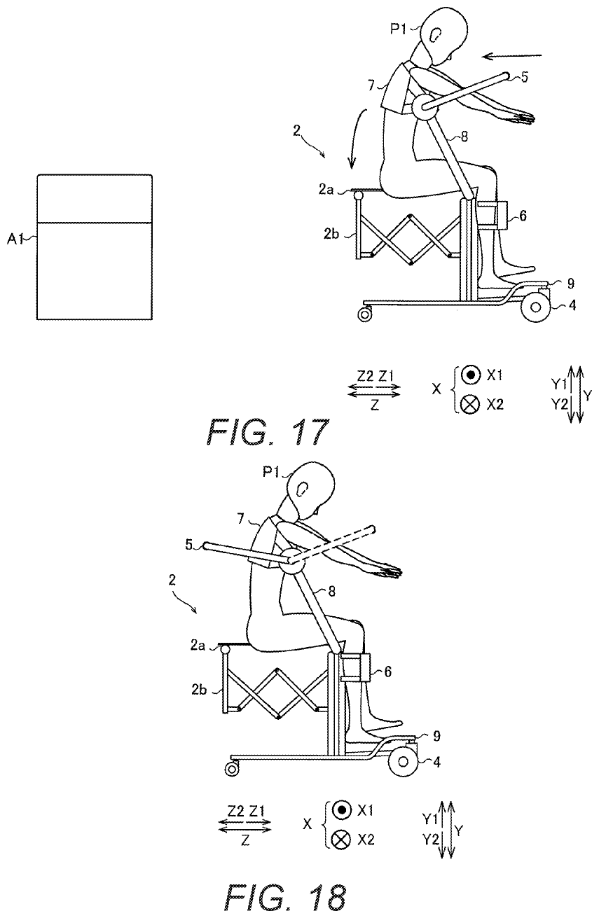

As shown in FIG. 16, the seat portion 2a of the seat member 2 is extended in the Z2 direction. Then, as shown in FIG. 17, when the handle member 5 is pushed in the Z2 direction, the movable arm 8 rotates in the Z2 direction. As a result, the care-receiver P1 who is in contact with the support member 3 can be pushed toward the seat portion 2a. Thus, the care-receiver P1 can be seated on the seat portion 2a. As a result, the care-receiver P1 is transferred from the bed A1 to the transfer device 100.

As shown in FIG. 18, the handle member 5 changes the position from the Z1 side to the Z2 side by being rotated. The transfer device 100 is then moved by being operated by the caregiver P2 from the Z2 side.

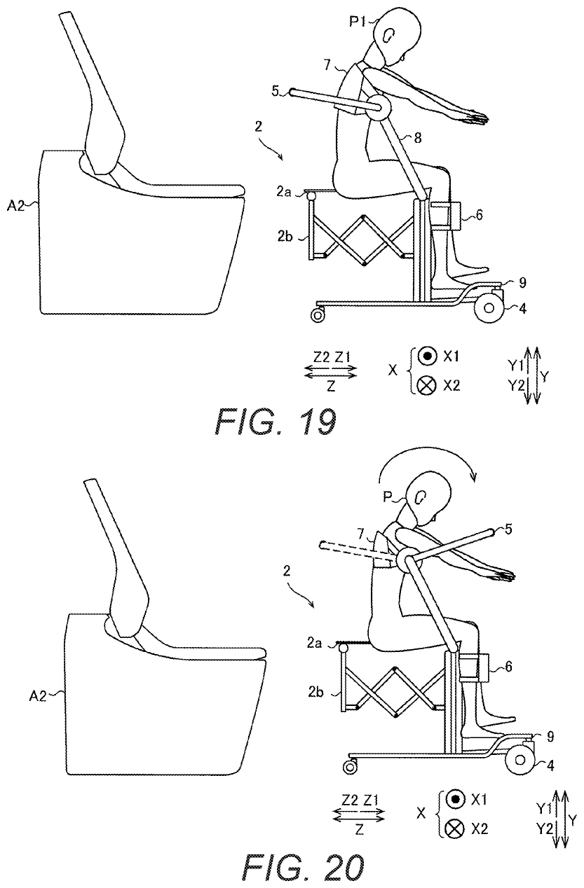

As shown in FIG. 19, after the transfer device 100 is moved to the toilet A2, it is turned around so that the back of the care-receiver P1 faces toward the toilet A2. Then, as shown in FIG. 20, the handle member 5 changes the position from the Z2 side to the Z1 side by being rotated.

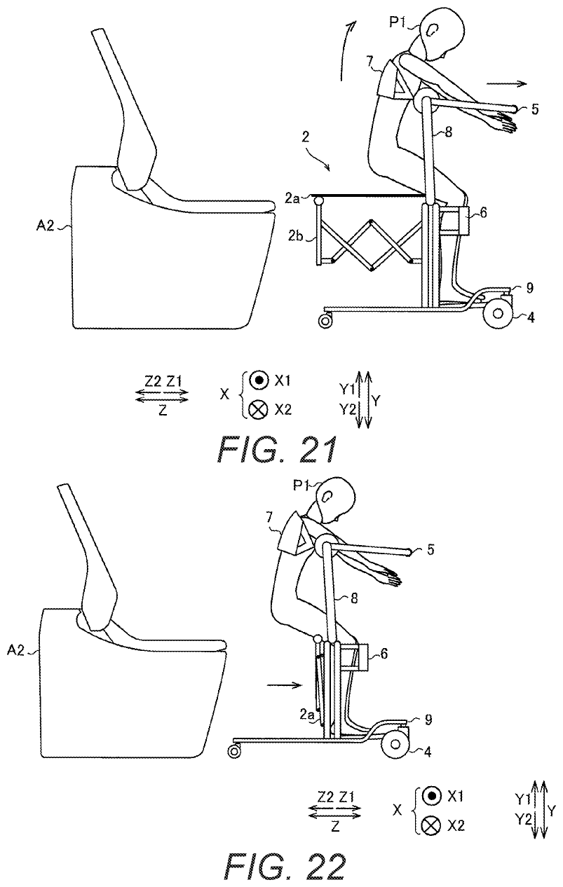

As shown in FIG. 21, the handle member 5 is pulled in the Z1 direction. As a result, the movable arm 8 is rotated toward the Z1 side, and the posture of the care-receiver P1 is changed. Specifically, the care-receiver P1 is placed in a state in which the waist is lifted up.

As shown in FIG. 22, in a state in which the posture of the care-receiver P1 is changed, the seat member 2 is retracted. Then, as shown in FIG. 23, the transfer device 100 is brought closer to the toilet A2. Specifically, the pair of the Z2 side end portions of the base frames 9 are moved so as to sandwich the toilet A2 therebetween.

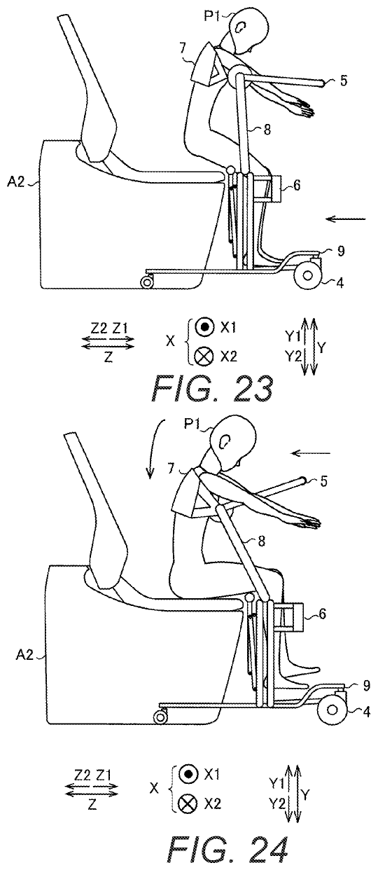

Then, as shown in FIG. 24, when the handle member 5 is pushed in the Z2 direction, the movable arm 8 rotates toward the Z2 side. As a result, the support member 3 pushes the care-receiver P1 toward the toilet A2, and the care-receiver P1 is seated on the toilet A2. As a result, the care-receiver P1 is transferred from the transfer device 100 to the toilet A2.

### Effects of First Embodiment

In the first embodiment, the following effects can be obtained.

With the first embodiment, as described above, the transfer device 100 comprises the support frame 1, the seat member 2, the support member 3, the casters 4, and the handle member 5. The care-receiver P1 is configured to be seated on the seat member 2. The seat member 2 is attached to the support frame 1 and is foldable or extendable. The support member 3 is attached to the support frame 1. The support member 3 is configured to support the upper body of the care-receiver P1 from the front. The casters 4 are provided below the support frame 1. The handle member 5 is attached to the support member 3. The handle member 5 is movable in the front-back direction of the support frame 1 and is configured to be grasped by the caregiver P2 during the transfer. With this configuration, the caregiver P2 can operate the transfer device 100 from the back side of the care-receiver P1 by changing the position of the handle member 5 rearward of the support frame 1 during the transfer. Thus, both the caregiver P2 and the care-receiver P1 can move while facing the direction of travel relative to the direction of movement. Also, by moving the handle member 5 forward of the support frame 1 during the transfer, the seat member 2 and the handle member 5 can be positioned on opposite sides of the support frame 1 in the front-back direction. With this configuration, the caregiver P2 can seat the care-receiver P1 on the seat member 2 from the side because the handle member 5 is not positioned on the side of the seat member 2. In addition, the support member 3 can support the upper body of the care-receiver P1 from the front. Thus, the care-receiver P1 can rest against (lean on) the support member 3 in front of the care-receiver P1 during the transfer and during the movement. Furthermore, by rotating the support member 3 in a state in which the upper body of the care-receiver P1 is supported by the support member 3, the posture of the care-receiver P1 can be changed, which facilitates the transfer operation. As a result, the ride comfort of the care-receiver P1 can be improved while improving operability.

With the first embodiment, as described above, the handle member 5 is movable in the front-back direction of the support frame 1 by being rotated. With this configuration, the position of the handle member 5 can be changed in the front-back direction of the support frame 1 by rotating the handle member 5. Thus, the caregiver P2 can easily change the position of the handle member 5.

With the first embodiment, as described above, the handle member 5 has the lock mechanisms 5c for restraining rotation of the handle member 5, and the handle member 5 becomes rotatable by releasing the lock mechanisms 5c. With this configuration, after the handle member 5 is rotated, the rotation is restrained by the lock mechanisms 5c. Thus, the transfer device 100 can be operated in a state in which the handle member 5 is fixed to the support member 3 during the transfer and during the movement.

With the first embodiment, as described above, the handle member 5 has the shaft portions 5a extending in the direction intersecting the direction in which the support member 3 extends, and the grasping portions 5b bent from the shaft portions 5a along the direction in which the support member 3 extends, and the handle member 5 becomes rotatable by releasing the lock mechanisms 5c by extending the grasping portions 5b along the direction intersecting the direction in which the support member 3 extends. With this configuration, the caregiver P2 does not need to perform complicated operations to release the lock mechanisms 5c because the lock mechanisms 5c are released by extending the grasping portions 5b along the direction intersecting the direction in which the support member 3 extends. This can improve operability.

With the first embodiment, as described above, the seat member 2 is extendable in the front-back direction. Here, with the seat member 2 folded in the up-down direction, the caregiver P2 needs to operate the seat member 2 while the caregiver P2 is lifting the care-receiver P1 above the position of the upper end of the seat member 2 folded to prevent the care-receiver P1 from contacting the seat member 2 that moves in the up-down direction (the vertical direction). Therefore, by making the seat member 2 extendable in the front-back direction, the seat member 2 can be extended by moving the seat member 2 in the front-back direction (the horizontal direction). Thus, the caregiver P2 can operate the seat member 2 without lifting the care-receiver P2 upward, compared to the seat member 2 that is folded in the up-down direction. As a result, the burden on the care-receiver P1 can be reduced. In addition, because the seat member 2 is extendable in the front-back direction, the seat member 2 does not protrude from the support frame 1 in the front-back direction when the seat member 2 is retracted. Thus, the transfer device 100 can be made compact in the front-back direction.

With the first embodiment, as described above, the seat member 2 includes the seat portion 2a on which the care-receiver P1 is configured to be seated, and the extension and retraction mechanism 2b configured to extend and retract the seat portion 2a, and the seat portion 2a is configured to be removable from the extension and retraction mechanism 2b. With this configuration, the seat portion 2a can be replaced with a clean seat portion 2a or removed and washed when the seat portion 2a becomes dirty. Thus, the sanitary condition of the transfer device 100 can be improved.

With the first embodiment, as described above, the transfer device 100 further comprises the pair of the base frames 9 provided below the seat member 2. The base frames 9 extend parallel to each other and rearward from the lower end portions of the support frame 1. The casters 4 are attached to the base frames 9. With this configuration, for example, when transferring the care-receiver P1 between the bed A1 and the transfer device 100, the base frames 9 can be inserted between the bed A1 and the floor. Thus, the transfer device 100 can be brought closer to the bed A1. Also, when transferring the care-receiver P1 between the toilet A2 and the transfer device 100, the pair of the base frames 9 can be placed with the toilet A2 being sandwiched between them. Thus, the toilet A2 and the transfer device 100 are brought closer. As a result, since the care-receiver P1 can be quickly transferred, the burden on the caregiver P2 and the care-receiver P1 can be reduced.

With the first embodiment, as described above, the transfer device 100 further comprises the movable arm 8 attaching the support member 3 to the support frame 1. The movable arm 8 supports the support member 3 in a cantilever manner at the one end of the lateral sides of the support member 3 and is rotatable with the support member 3 as the handle member 5 moving in the up-down direction. With this configuration, the care-receiver P1 can be transferred to the transfer device 100 from the side where the movable arm 8 is not provided. In addition, since the movable arm 8 rotates together with the support member 3 as the handle member 5 moving in the up-down direction, the care-receiver P1 can be prevented from contacting the movable arm 8 when the posture of the care-receiver P1 is changed by rotating the support member 3.

### Second Embodiment

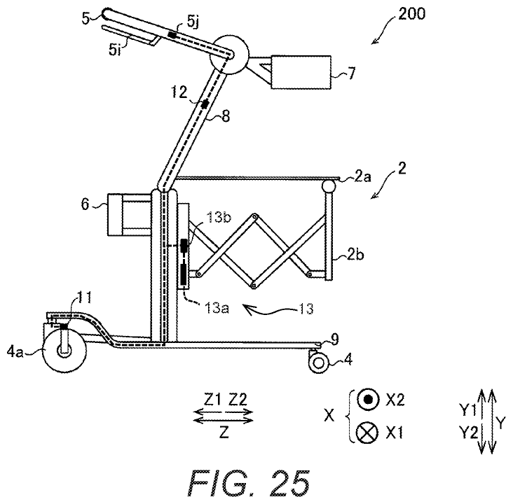

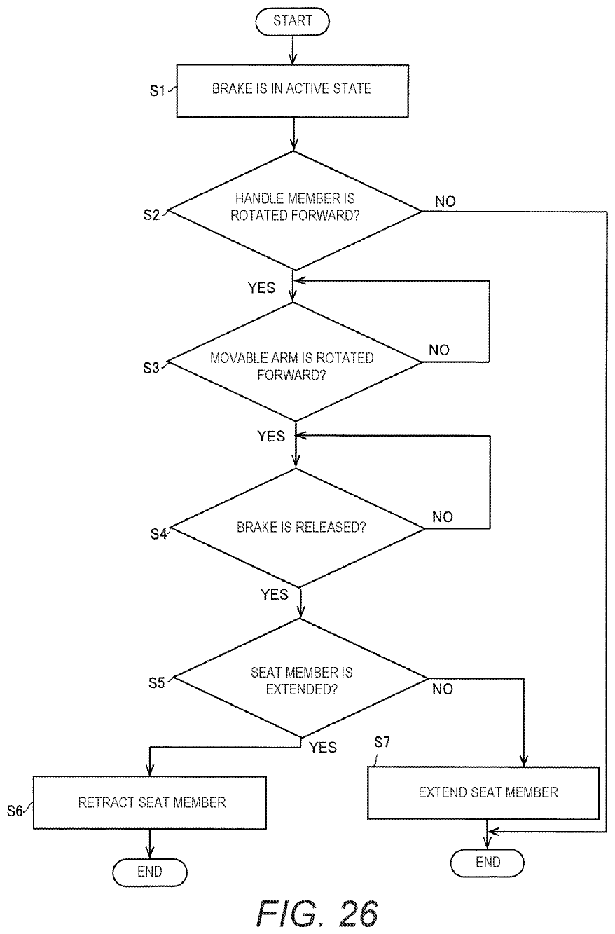

Referring to FIGS. 25 and 26, a transfer device 200 according to a second embodiment will be described. In this second embodiment, the handle member 5 is provided with a brake 5i. The transfer device 200 is also equipped with a first sensor 11, a second sensor 12, and a drive mechanism 13. The same symbols will be used for the same configuration as in the first embodiment above, and a detailed description will be omitted.

The brake 5i is attached to the Y2 side of the shaft portion 5a of the handle member 5. The brake 5i includes, for example, a brake lever and a brake wire (not shown), while a rotation restraining member 4a is attached to the caster 4. By operating the brake lever of the brake 5i, the brake wire pulls the rotation restraining member 4a in a direction of contacting the caster 4 and the rotation restraining member 4a contacts the caster 4, which changes the brake 5i to an active state. In the illustrated embodiment, the brake 5i is attached to one of the shaft portions 5a, but the present invention is not limited to this. For example, brakes 5i can be attached to the shaft portions 5a to restrain rotation of the casters 4.

The first sensor 11 is configured to detect the active state or an inactive state of the brake 5i. The first sensor 11 is, for example, installed near the caster 4 and detects the contact or non-contact state of the rotation restraining member 4a to detect the active state or the inactive state of the brake 5i. In the illustrated embodiment, the first sensor 11 can be a pressure sensor that detects pressure to the caster 4 exerted by the rotation restraining member 4a or other sensors that can detects contact of the rotation restraining member 4a relative to the caster 4.

The second sensor 12 is configured to detect the rotation of the movable arm 8 from the initial position. The initial position is a state in which it is inclined by a predetermined angle toward the Z2 side. The second sensor 12 is an angle sensor or rotation sensor that detects the rotation angle of the movable arm based on the angle of the initial position.

The drive mechanism 13 is a mechanism for extending and retracting the seat member 2. The drive mechanism 13 is configured to operate based on the detection results of the first sensor 11 and the second sensor 12. The drive mechanism 13 includes, for example, an electric actuator 13a. In particular, the drive mechanism 13 includes an electric motor that generates rotary motion, which is converted into linear motion by the linkage mechanism of the extension and retraction mechanism 2b. The connection between the drive mechanism 13 and the extension and retraction mechanism 2b to convert the rotary motion of the actuator to the linear motion of the linkage mechanism are relatively conventional, and thus the detailed descriptions thereof will be omitted for the sake of brevity.

A detector 5j is attached to the handle member 5. The detector 5j can be an inclination sensor that detects the inclination angle of the handle member 5 with respect to the support member 3. The inclination angle is 90 degrees when orthogonal to the support member 3, and a value smaller than 90 degrees is detected when the handle member 5 is positioned at the front side, and a value greater than 90 degrees is detected when the handle member 5 is positioned at the rear side. In the illustrated embodiment, the drive mechanism 13 further includes an electric controller 13b operatively coupled to the electric actuator 13a, the first and second sensors 11 and 12 and the detector 5j. The electric controller 13b operates the actuator 13a based on the detection results of the first and second sensors 11 and 12 and the detector 5j to extend and retract the seat member 2 by the extension and retraction mechanism 2b. In the illustrated embodiment, the electric controller 13b includes a processor which is a hardware device capable of executing a software program, and does not include a human. In the illustrated embodiment, the electric controller 13b includes a CPU. However, in some cases, the electric controller 13b can be configured to comprise, instead of the CPU or in addition to the CPU, programmable logic devices such as a DSP (Digital Signal Processing or Processor), an FPGA (Field Programmable Gate Array), and the like. In addition, the electric controller 13b can include a plurality of processors or CPUs that execute the processing sequences of the present disclosure together.

Based on FIG. 26, the operational relationship between the first sensor 11, the second sensor 12, and the drive mechanism 13 will be explained. First, as step S1, the first sensor 11 detects that the brake 5i is in the active state. A state in which the brake 5i is activated is considered to be a state in which the transfer device 200 is stopped from moving. Next, in step S2, the step to proceed differs depending on whether the handle member 5 has been rotated forward or not. Specifically, if the angle of the handle member 5 detected by the detector 5j is less than 90 degrees, then the process proceeds to step S3 as the handle member 5 is positioned in the front side, and in other cases, the process ends.

In step S3, the step to proceed differs depending on whether the movable arm 8 is rotated forward or not. Specifically, if the second sensor 12 detects the forward rotation of the movable arm 8 from the initial position, then it proceeds to step S4, and if not, step S3 will be repeated. If the second sensor 12 detects the forward rotation of the movable arm 8 from the initial position, then it is a state in which the care-receiver P1 is leaning on the support member 3.

In step S4, the step to proceed differs depending on whether the brake 5i is released or not. Specifically, if the first sensor 11 detects that the brake 5i is in the inactive state, then it proceeds to step 5, and if not, step S4 will be repeated. If the first sensor 11 detects that the brake 5i is in the inactive state, then it is a state in which the transfer device 200 is moved and the seat member 2 is about to be extended or retracted.

In step S5, the step to proceed differs depending on the state of the seat member 2. If the seat member 2 is extended, it proceeds to step S6, and the drive mechanism 13 retracts the seat member 2. On the other hand, if the seat member 2 is retracted, it proceeds to step S7, and the drive mechanism 13 extends the seat member 2.

Other configurations of the transfer device 200 according to the second embodiment are the same as those of the transfer device 200 according to the first embodiment.

### Effects of Second Embodiment

In the second embodiment, the following effects can be obtained.

With the second embodiment, as described above, the transfer device 200 comprises the support frame 1, the seat member 2, the support member 3, the casters 4, and the handle member 5. The care-receiver P1 is configured to be seated on the seat member 2. The seat member 2 is attached to the support frame 1 and is foldable or extendable. The support member 3 is attached to the support frame 1. The support member 3 is configured to support the upper body of the care-receiver P1 from the front. The casters 4 are provided below the support frame 1. The handle member 5 is attached to the support member 3. The handle member 5 is movable in the front-back direction of the support frame 1 and is configured to be grasped by the caregiver P2 during the transfer. With this configuration, the caregiver P2 can operate the transfer device 200 from the back side of the care-receiver P1 by changing the position of the handle member 5 rearward of the support frame 1 during the transfer. Thus, both the caregiver P2 and the care-receiver P1 can move while facing the direction of travel relative to the direction of movement. Also, by moving the handle member 5 forward of the support frame 1 during the transfer, the seat member 2 and the handle member 5 can be positioned on opposite sides of the support frame 1 in the front-back direction. With this configuration, the caregiver P2 can seat the care-receiver P1 on the seat member 2 from the side because the handle member 5 is not positioned on the side of the seat member 2. In addition, the support member 3 can support the upper body of the care-receiver P1 from the front. Thus, the care-receiver P1 can rest against (lean on) the support member 3 in front of the care-receiver P1 during the transfer and during the movement. Furthermore, by rotating the support member 3 in a state in which the upper body of the care-receiver P1 is supported by the support member 3, the posture of the care-receiver P1 can be changed, which facilitates the transfer operation. As a result, the ride comfort of the care-receiver P1 can be improved while improving operability.

With the second embodiment, as described above, the handle member 5 has the brake 5i for stopping the rotation of the caster 4. The transfer device 200 further comprises the first sensor 11 configured to detect the active state or the inactive state of the brake 5i, the second sensor 12 configured to detect rotation of the movable arm 8 from the initial position, and the drive mechanism 13 configured to extend and retract the seat member 2 based on the detection results of the first sensor 11 and the second sensor 12. Here, when the brake 5i becomes the inactive state after being activated, it is considered to be a case in which the transfer device 200 is moved to extend or retract the seat member 2. Also, a state in which the movable arm 8 is rotated from the initial position is considered to be a state in which the care-receiver P1 is leaning on the support member 3. Therefore, with this configuration, it is possible to determine from the detection results of the first sensor 11 and the second sensor 12 that it is in a stage of extending or retracting the seat member 2, and the seat member 2 can be automatically extended or retracted. As a result, the caregiver P2 does not need to manually extend or retract the seat member 2. Thus, the workload of the caregiver P2 can be reduced.

Other effects of the transfer device 200 according to the second embodiment are the same as those of the transfer device 100 according to the first embodiment.

### Modification Examples

The first embodiment and the second embodiment disclosed here should be considered in all respects to be illustrative and not restrictive. The scope of the invention is indicated by the claims, not by the description of the embodiments described above, and furthermore includes all changes (modification examples) within the meaning and scope equivalent to the claims.

For example, in the first and second embodiments, examples are shown in which the handle member 5 is configured to change the position in the front-back direction of the support frame 1 by being rotated, but the present invention is not limited to this. In the present invention, for example, the handle member 5 may be detachably attached to the support member 3 and configured to change the position in the front-back direction of the support frame 1 by being detached. With this configuration, the caregiver P2, for example, can remove the handle member 5 that has been positioned on the support member 3 so that it extends rearward of the support frame 1 from the support member 3, and attach the handle member 5 to the support member 3 after changing the orientation of the handle member 5 so as to extend forward of the support frame 1. As a result, the caregiver P2 can easily change the orientation of the handle member 5.

For example, in the first and second embodiments, examples are shown in which the support frame 1 is formed of the first pillar 1a and the second pillar 1b, but the present invention is not limited to this. In the present invention, for example, the support frame 1 may be formed of only the first pillar 1a.

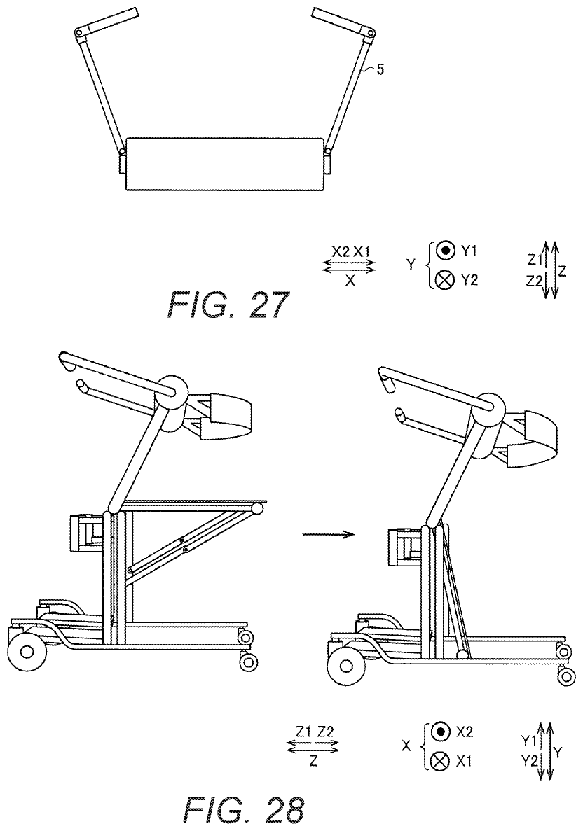

In the first and second embodiments above, examples are shown in which the lock mechanisms 5c are configured to be released and the handle member 5 becomes rotatable by extending the grasping portions 5b along the direction intersecting the direction in which the support member 3 extends, but the present invention is not limited to this. In the present invention, as shown in FIG. 27, for example, the lock mechanisms 5c may be configured to be released to make handle member 5 rotatable by, for example, rotating the handle member 5 sideways relative to the support member 3. In this case, by rotating the handle member 5 sideways, the cam 5g in the shaft portion 5a pushes the connecting rod 5e downward (in the Y2 direction), and the locking state may be released by the connecting rod 5e pushing the stopper 5d in a direction away from the gear 5h. FIG. 27 is a diagram showing the handle member 5 as viewed from above (the Y1 side) in a state in which the handle member 5 is positioned in the front (the Z1 side) of the support frame 1 (the state shown in FIG. 4).

In the first and second embodiments above, examples are shown in which the lock mechanisms 5c are configured so that the rotation is restricted by entering the locked state, but the present invention is not limited to this. In the present invention, it may be configured so that the angle of the handle member 5 can be fine-tuned after it enters the locked state.

In the first and second embodiments above, examples are shown in which the seat member 2 is extendable in the front-back direction, but the present invention is not limited to this. In the present invention, for example, as shown in FIG. 28, it can be configured such that the seat member 2 can be folded by being rotated.

In the first and second embodiments above, examples are shown in which the size of the diameter (of the wheels) of the casters 4 in the front is different from the size of the diameter (of the wheels) of the casters 4 in the rear, but the present invention is not limited to this. In the present invention, for example, the size of the diameter (of the wheels) of the casters 4 in the front and the size of the diameter (of the wheels) of the casters 4 in the rear may be the same.

In the first and second embodiments above, examples are shown in which the rear side of the base frames 9 is configured lower than the front side, but the present invention is not limited to this. In the present invention, the height of the base frames 9 at the front side and the rear side may be the same.

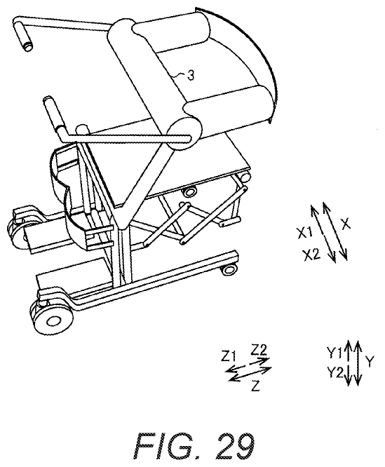

In the first and second embodiments above, examples are shown in which the support member 3 supports the care-receiver P1 from the front, but the present invention is not limited to this. In the present invention, the support member 3 may be configured to support the care-receiver P1 from the front and from both lateral sides. In this case, the support member 3 may be U-shaped, as shown in FIG. 29. The support member 3 may be configured to be inflated by air.

(1) In view of the state of the known technology, a transfer device according to an aspect of this disclosure comprises a support frame, a seat member, a support member, at least one caster, and a handle member. A care-receiver is configured to be seated on the seat member. The seat member is attached to the support frame and is foldable or extendable. The support member is attached to the support frame. The support member is configured to support an upper body of the care-receiver from front. The at least one caster is provided below the support frame. The handle member is attached to the support member. The handle member is movable in a front-back direction of the support frame and is configured to be grasped by a caregiver during a transfer.

The transfer device according to the aspect of this disclosure comprises, as described above, the handle member attached to the support member. The handle member is configured to rotate the support member during the transfer, for example. The handle member is movable in the front-back direction of the support frame. The handle member is configured to be grasped by the caregiver during the transfer. With this configuration, the caregiver can operate the transfer device from the back side of the care-receiver by changing the position of the handle member rearward of the support frame during the transfer. Thus, both the caregiver and the care-receiver can move while facing the direction of travel relative to the direction of movement. Also, by moving the handle member forward of the support frame during the transfer, the seat member and the handle member can be positioned on opposite sides of the support frame in the front-back direction. With this configuration, the caregiver can seat the care-receiver on the seat member from the side because the handle member is not positioned on the side of the seat member. In addition, the support member can support the upper body of the care-receiver from the front. Thus, the care-receiver can rest against (lean on) the support member in front of the care-receiver during the transfer and during the movement. Furthermore, by rotating the support member in a state in which the upper body of the care-receiver is supported by the support member, the posture of the care-receiver can be changed, which facilitates the transfer operation. As a result, the ride comfort of the care-receiver can be improved while improving operability.

(2) In accordance with a preferred embodiment according to the transfer device mentioned above, the handle member is movable in the front-back direction of the support frame by being rotated. With this configuration, the position of the handle member can be changed in the front-back direction of the support frame by rotating the handle member. Thus, the caregiver can easily change the position of the handle member.

(3) In accordance with a preferred embodiment according to any one of the transfer devices mentioned above, the handle member has a lock mechanism for restraining rotation of the handle member, and the handle member becomes rotatable by releasing the lock mechanism. With this configuration, after the handle member is rotated, the rotation is restrained by the lock mechanism. Thus, the transfer device can be operated in a state in which the handle member is fixed to the support member during the transfer and during the movement.

(4) In accordance with a preferred embodiment according to any one of the transfer devices mentioned above, the handle member has a shaft portion extending in a direction intersecting a direction in which the support member extends, and a grasping portion bent from the shaft portion along the direction in which the support member extends, and the handle member becomes rotatable by releasing the lock mechanism by extending the grasping portion along the direction intersecting the direction in which the support member extends. With this configuration, the caregiver does not need to perform complicated operations to release the lock mechanism because the lock mechanism is released by extending the grasping portion along the direction intersecting the direction in which the support member extends. This can improve operability.

(5) In accordance with a preferred embodiment according to any one of the transfer devices mentioned above, the handle member becomes rotatable by releasing the lock mechanism by rotating the handle member sideways relative to the support member. With this configuration, the direction of rotation when changing the position of the handle member and the direction of rotation when releasing the lock mechanism can be different. Thus, there is no need to provide a more complicated mechanism than when configured to rotate in the same direction.

(6) In accordance with a preferred embodiment according to any one of the transfer devices mentioned above, the handle member is removably attached to the support member. With this configuration, the caregiver can, for example, remove the handle member positioned on the support member so that it extends rearward of the support frame from the support member, change the orientation of the handle member so that it extends forward of the support frame, and attach the handle member to the support member. As a result, the caregiver can easily change the orientation of the handle member.

(7) In accordance with a preferred embodiment according to any one of the transfer devices mentioned above, the seat member is extendable in the front-back direction. Here, with the seat member folded in an up-down direction, the caregiver needs to operate the seat member while the caregiver is lifting the care-receiver above the position of the upper end of the seat member folded to prevent the care-receiver from contacting the seat member that moves in the up-down direction (vertical direction). Therefore, by making the seat member extendable in the front-back direction, the seat member can be extended by moving the seat member in the front-back direction (horizontal direction). Thus, the caregiver can operate the seat member without lifting the care-receiver upward, compared to a seat member that is folded in the up-down direction. As a result, the burden on the care-receiver can be reduced. In addition, because the seat member is extendable in the front-back direction, the seat member does not protrude from the support frame in the front-back direction when the seat member is retracted. Thus, the transfer device can be made compact in the front-back direction.

(8) In accordance with a preferred embodiment according to any one of the transfer devices mentioned above, the seat member includes a seat portion on which the care-receiver is configured to be seated, and an extension and retraction mechanism configured to extend and retract the seat portion, and the seat portion is removable from the extension and retraction mechanism. With this configuration, the seat portion can be replaced with a clean seat portion or removed and washed when the seat portion becomes dirty. Thus, the sanitary condition of the transfer device can be improved.

(9) In accordance with a preferred embodiment according to any one of the transfer devices mentioned above, the extension and retraction mechanism includes a scissors mechanism.

(10) In accordance with a preferred embodiment according to any one of the transfer devices mentioned above, the transfer device further comprises a pair of base frames provided below than the seat member. The base frames extend parallel to each other and rearward from lower end portions of the support frame. The at least one caster is attached to the base frames. With this configuration, for example, when transferring the care-receiver between a bed and the transfer device, the base frames can be inserted between the bed and the floor. Thus, the transfer device can be brought closer to the bed. Also, when transferring the care-receiver between a toilet and the transfer device, the base frames can be placed with the toilet being sandwiched between them. Thus, the toilet and the transfer device are brought closer. As a result, the care-receiver can be easily transferred.

(11) In accordance with a preferred embodiment according to any one of the transfer devices mentioned above, the base frames are laterally spaced away from each other.

(12) In accordance with a preferred embodiment according to any one of the transfer devices mentioned above, the transfer device further comprises a foot rest disposed between the base frames.

(13) In accordance with a preferred embodiment according to any one of the transfer devices mentioned above, the foot rest is disposed forward of the lower end portions of the support frame.

(14) In accordance with a preferred embodiment according to any one of the transfer devices mentioned above, the transfer device further comprises a movable arm attaching the support member to the support frame. The movable arm supports the support member in a cantilever manner at one end of lateral sides of the support member and is rotatable with the support member as the handle member moving in an up-down direction. With this configuration, the care-receiver can be transferred to the transfer device from the side where the movable arm is not provided. In addition, since the movable arm rotates together with the support member as the handle member moving in the up-down direction, the care-receiver can be prevented from contacting the movable arm when the posture of the care-receiver is changed by rotating the support member.

(15) In accordance with a preferred embodiment according to any one of the transfer devices mentioned above, the handle member has a brake for stopping the rotation of the at least one caster. The transfer device further comprises a first sensor configured to detect an active state or an inactive state of the brake, a second sensor configured to detect rotation of the movable arm from an initial position, and a drive mechanism configured to extend and retract the seat member based on detection results of the first sensor and the second sensor. Here, when the brake becomes the inactive state after being activated, it is considered to be a case in which the transfer device is moved to extend or retract the seat member. Also, a state in which the movable arm is rotated from the initial position is considered to be a state in which the care-receiver is leaning on the support member. Therefore, with this configuration, it is possible to determine from the detection results of the first sensor and the second sensor that it is in a stage of extending or retracting the seat member, and the seat member can be automatically extended or retracted. As a result, the caregiver does not need to manually extend or retract the seat member. Thus, the workload of the caregiver can be reduced.

(16) In accordance with a preferred embodiment according to any one of the transfer devices mentioned above, the transfer device further comprises a front holding portion disposed forward of the support frame below the seat member.

(17) In accordance with a preferred embodiment according to any one of the transfer devices mentioned above, the front holding portion is arranged such that the front holding portion is configured to support a leg of the care-receiver.

(18) In accordance with a preferred embodiment according to any one of the transfer devices mentioned above, the transfer device further comprises a back holding portion disposed rearward of the support frame above the seat member.

(19) In accordance with a preferred embodiment according to any one of the transfer devices mentioned above, the back holding portion is arranged such that the back holding portion is configured to support a back of the care-receiver between the back holding portion and the support member.

(20) In accordance with a preferred embodiment according to any one of the transfer devices mentioned above, the at least one casters include a front caster and a rear caster, and the front caster having a diameter that is larger than that of the rear caster.

According to the present disclosure, it is possible to provide a transfer device that can improve the ride comfort of the care-receiver while improving operability.

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts unless otherwise stated.

As used herein, the following directional terms “forward”, “rearward”, “front”, “rear”, “up”, “down”, “above”, “below”, “upward”, “downward”, “top”, “bottom”, “side”, “vertical”, “horizontal”, “perpendicular” and “transverse” as well as any other similar directional terms refer to those directions of a transfer device in an upright position on a horizontal surface. Accordingly, these directional terms, as utilized to describe the transfer device should be interpreted relative to a transfer device in an upright position on a horizontal surface.

The phrase “at least one of” as used in this disclosure means “one or more” of a desired choice. For one example, the phrase “at least one of” as used in this disclosure means “only one single choice” or “both of two choices” if the number of its choices is two. For another example, the phrase “at least one of” as used in this disclosure means “only one single choice” or “any combination of equal to or more than two choices” if the number of its choices is equal to or more than three. Also, the term “and/or” as used in this disclosure means “either one or both of”.

The term “attached” or “attaching”, as used herein, encompasses configurations in which an element is directly secured to another element by affixing the element directly to the other element; configurations in which the element is indirectly secured to the other element by affixing the element to the intermediate member(s) which in turn are affixed to the other element; and configurations in which one element is integral with another element, i.e. one element is essentially part of the other element. This definition also applies to words of similar meaning, for example, “joined”, “connected”, “coupled”, “mounted”, “bonded”, “fixed” and their derivatives. Finally, terms of degree such as “substantially”, “about” and “approximately” as used herein mean an amount of deviation of the modified term such that the end result is not significantly changed.

While only selected embodiments have been chosen to illustrate the present invention, it will be apparent to those skilled in the art from this disclosure that various changes and modifications can be made herein without departing from the scope of the invention as defined in the appended claims. For example, unless specifically stated otherwise, the size, shape, location or orientation of the various components can be changed as needed and/or desired so long as the changes do not substantially affect their intended function. Unless specifically stated otherwise, components that are shown directly connected or contacting each other can have intermediate structures disposed between them so long as the changes do not substantially affect their intended function. The functions of one element can be performed by two, and vice versa unless specifically stated otherwise. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such feature(s). Thus, the foregoing descriptions of the embodiments according to the present invention are provided for illustration only, and not for the purpose of limiting the invention as defined by the appended claims and their equivalents.

What is claimed is:

1. A transfer device comprising:
a support frame;
a seat member on which a care-receiver is configured to be seated, the seat member being attached to the support frame and being foldable or extendable;
a support member attached to the support frame, the support member being configured to support an upper body of the care-receiver from front;
at least one caster provided below the support frame; and
a handle member attached to the support member, the handle member being movable in a front-back direction of the support frame and being configured to be grasped by a caregiver during a transfer.

2. The transfer device according to claim 1, wherein
the handle member is movable in the front-back direction of the support frame by being rotated.

3. The transfer device according to claim 2, wherein
the handle member has a lock mechanism for restraining rotation of the handle member, and
the handle member becomes rotatable by releasing the lock mechanism.

4. The transfer device according to claim 3, wherein
the handle member has a shaft portion extending in a direction intersecting a direction in which the support member extends, and a grasping portion bent from the shaft portion along the direction in which the support member extends, and
the handle member becomes rotatable by releasing the lock mechanism by extending the grasping portion along the direction intersecting the direction in which the support member extends.

5. The transfer device according to claim 3, wherein
the handle member becomes rotatable by releasing the lock mechanism by rotating the handle member sideways relative to the support member.

6. The transfer device according to claim 1, wherein
the handle member is removably attached to the support member.

7. The transfer device according to claim 1, wherein
the seat member is extendable in the front-back direction.

8. The transfer device according to claim 1, wherein
the seat member includes a seat portion on which the care-receiver is configured to be seated, and an extension and retraction mechanism configured to extend and retract the seat portion, and
the seat portion is removable from the extension and retraction mechanism.

9. The transfer device according to claim 8, wherein
the extension and retraction mechanism includes a scissors mechanism.

10. The transfer device according to claim 1, further comprising
a pair of base frames provided below the seat member, the base frames extending parallel to each other and rearward from lower end portions of the support frame, and
the at least one caster being attached to the base frames.

11. The transfer device according to claim 10, wherein
the base frames are laterally spaced away from each other.

12. The transfer device according to claim 10, further comprising
a foot rest disposed between the base frames.

13. The transfer device according to claim 12, wherein
the foot rest is disposed forward of the lower end portions of the support frame.

14. The transfer device according to claim 1, further comprising
a movable arm attaching the support member to the support frame, the movable arm supporting the support member in a cantilever manner at one end of lateral sides of the support member and being rotatable with the support member as the handle member moving in an up-down direction.

15. The transfer device according to claim 14, wherein
the handle member has a brake for stopping rotation of the at least one caster,
the transfer device further comprising
a first sensor configured to detect an active state or an inactive state of the brake,
a second sensor configured to detect rotation of the movable arm from an initial position, and
a drive mechanism configured to extend and retract the seat member based on detection results of the first sensor and the second sensor.

16. The transfer device according to claim 1, further comprising
a front holding portion disposed forward of the support frame below the seat member.

17. The transfer device according to claim 16, wherein
the front holding portion is arranged such that the front holding portion is configured to support a leg of the care-receiver.

18. The transfer device according to claim 1, further comprising
a back holding portion disposed rearward of the support frame above the seat member.

19. The transfer device according to claim 18, wherein
the back holding portion is arranged such that the back holding portion is configured to support a back of the care-receiver between the back holding portion and the support member.

20. The transfer device according to claim 1, wherein
the at least one casters include a front caster and a rear caster, and
the front caster having a diameter that is larger than that of the rear caster.
